(19) United States
(12) Patent Application Publication
(10) Pub. No.: US 2014/0049872 A1
(43) Pub. Date: Feb. 20, 2014

(54) METAL-OXIDE-METAL CAPACITOR ABLE TO REDUCE AREA OF CAPACITOR ARRAYS

(71) Applicants: Guan-Ying Huang, Tainan (TW); Jin-Fu Lin, Tainan (TW)

(72) Inventors: Guan-Ying Huang, Tainan (TW); Jin-Fu Lin, Tainan (TW)

(73) Assignees: HIMAX TECHNOLOGIES LIMITED, Tainan City (TW); NCKU RESEARCH AND DEVELOPMENT FOUNDATION, Tainan (TW)

(21) Appl. No.: 13/587,319

(22) Filed: Aug. 16, 2012

(51) Int. Cl. H01G 4/30

(52) U.S. Cl. CPC H01G 4/30
USPC 361/301.4

(57) ABSTRACT

A metal-oxide-metal (MOM) capacitor able to reduce area of capacitor arrays is revealed. The MOM capacitor mainly includes at least three parallel conducting layers. Each parallel conducting layer consists of a first conductive plate, a second conductive plate disposed around the first conductive plate. There is a preset distance between the first conductive plate and the second conductive plate. The first conductive plates are electrically connected by at least one first via while the second conductive plates are electrically connected by at least one second via. Thereby, while being applied to capacitor arrays, the second conductive plates of the two adjacent MOM capacitors are connected together and shared with each other, so as to significantly reduce area of the capacitor array, improve circuit density and further optimize the layout efficiency of the chip design.

### BACKGROUND OF THE INVENTION

1. Field of the Invention

The present invention relates to a metal-oxide-metal (MOM) capacitor able to reduce area of capacitor arrays, especially to a metal-oxide-metal (MOM) capacitor with a columnar structure in which first conductive plates are electrically connected by at least one via to form a bottom plate of the capacitor while second conductive plates outside are electrically connected by at least one via to form a top plate of the capacitor. While being applied to capacitor arrays, the layout is dramatically reduced and the circuit density is increased. Thus the chip area is significantly reduced.

2. Description of Related Art

Along with progress in manufacturing process, metal-oxide-semiconductor (MOS) is minimized and getting compact. The number of MOS stacked on a chip is increased. Thus a plurality of complicated circuit can be integrated into the same chip. However, the integrated chip needs an analog-to-digital converter (ADC) in order to convert external analog signals to digital signals. Then digital signal processor (DSP) circuit performs following signal processing. Thus ADC has played an important role in the integrated system now and various kinds of related techniques have been developed.

There are multiple types of ADC. The most common types of ADC include a direct-conversion ADC (or flash ADC), a pipeline ADC and a successive-approximation (SAR) ADC. Each type of the above ADC has its own advantages. Users can select according to their requirements. Compared with other ADC, the successive-approximation ADC has lower power consumption, smaller area and lower cost. Thus it has received a great attention in recent studies. Referring to FIG. 8, a schematic drawing showing a 10-bit successive-approximation ADC 6 available now is revealed. The SAR ADC 6 mainly includes a comparator 61, a switching circuit 62, and a successive approximation register control/logic circuit 63. For one 10-bit successive-approximation ADC, it needs a 10-bit precision digital to analog converter (DAC). In order to reduce power consumption, this DAC is generally a capacitor array, as C₁˜C₁₀ shown in FIG. 8. The capacitance of the capacitor array increases exponentially with the resolution of the DAC. For an N-bit DAC, it needs 2^{N} capacitors. The total area and power consumption of the successive-approximation ADC 6 depends on the capacitance and area of each capacitor. The MOM capacitor has advantages of easy manufacturing of a capacitor with smaller capacitance as well as easy placement and routing. In consideration of smaller capacitance and minimized area, most of successive-approximation ADC is formed by MOM capacitors.

Referring to FIG. 9, a metal-oxide-metal (MOM) capacitor available now is disclosed. The MOM capacitor 7 mainly includes a metal plate at an upper layer 71 and a metal plate at a lower layer 72. The metal plates 71, 72 are disconnected and separated. When the MOM capacitor 7 is used to form a successive-approximation ADC, the layout of the whole capacitor array is shown in FIG. 10. The metal plates at an upper layer 71 of the MOM capacitor 7 are connected in series by first connecting wires 711 while the metal plates at a lower layer 72 are connected in series by second connecting wires 721. Because the metal plates at a lower layer 72 of the MOM capacitor 7 are separated from one another so that the second connecting wires 721 are required for placement and routing in the capacitor array. However, such routing way needs channels 8 left between two adjacent MOM capacitors 7 for routing of the metal plates at a lower layer 72, so that the channels 8 will cover too much area on the whole layout, occupy a certain area on the chip, cause reduction of the circuit density and further affect the layout efficiency of the chip design.

### SUMMARY OF THE INVENTION

There are many shortcomings of the above MOM capacitor available now while being applied to successive-approximation (SAR) ADC. There is room for improvement and a need to provide a novel MOM capacitor.

Therefore it is a primary object of the present invention to provide a metal-oxide-metal capacitor with a columnar structure in which first conductive plates in a core are connected by at least one via to form a bottom plate of the capacitor while second conductive plates outside are connected by at least one via to form a top plate of the capacitor. When the MOM capacitor is applied to capacitor arrays, the layout area is significantly reduced and the circuit density is increased. Thus the chip area is dramatically reduced.

In order to achieve the above object, a metal-oxide-metal (MOM) capacitor able to reduce area of capacitor arrays according to the present invention includes at least three parallel conducting layers. Each conducting layer consists of a first conductive plate, and a second conductive plate arranged around the first conductive plate. There is a preset distance between the first conductive plate and the second conductive plate. The first conductive plates are connected to one another by at least one first via while the second conductive plates are connected to one another by at least one second via. While being used to form capacitor arrays, the second conductive plates of adjacent MOM capacitors are connected together and shared with each other.

In the MOM capacitor, the first conductive plate on one end is further electrically connected to a first metal plate by at least one third via, and a metal shielding layer is disposed around and corresponding to the first metal plate. The first metal plate is electrically connected to a second metal plate by at least one fourth via. The metal shielding layer is used to electrically isolate the second metal plate from the second conductive plate so as to prevent the second metal plate from being affected by the capacitance of the second conductive plate and other conductive structures thereabove.

In the above MOM capacitor able to reduce area of capacitor arrays, the shape of the metal shielding layer is corresponding to the shape of the second conductive plate.

Thereby while being applied to DAC, there is no need to have channel for replacement and routing between two adjacent MOM capacitors as the layout of the conventional chip. Thus the area of the capacitor array is significantly reduced and the circuit density is improved. Therefore the layout efficiency of the chip design is optimized.

Moreover, another metal-oxide-metal (MOM) capacitor able to reduce area of capacitor arrays according to the present invention is provided. The MOM capacitor includes at least three parallel conducting layers. Each conducting layer consists of a first conductive plate, and a second conductive plate arranged around the first conductive plate. There is a preset distance between the first conductive plate and the second conductive plate. The first conductive plates are connected to one another by at least one first via while the second conductive plates are connected to one another by at least one second via. At least one through slot is disposed on the second conductive plate of at least one parallel conducting layer. An electrical guiding part corresponding to the through slot is projectingly arranged at the first conductive plate.

In the above MOM capacitor able to reduce area of capacitor arrays, the parallel conducting layer on each of two sides is electrically connected to an external conductive plate by at least one fifth via.

Thereby the first conductive plate is electrically connected to another MOM capacitor by the extended electrical guiding part. And a plurality of MOM capacitors can be connected horizontally so as to achieve the capacitance required.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment of a metal-oxide-metal capacitor according to the present invention;

FIG. 2 is a schematic drawing showing layout of a capacitor array of an embodiment applied to digital-to-analog converter according to the present invention;

FIG. 3 is a photo of a chip with an embodiment of a metal-oxide-metal capacitor applied to a successive-approximation (SAR) ADC according to the present invention;

FIG. 4 is a photo of a chip with a metal-oxide-metal capacitor available now applied to a SAR ADC;

FIG. 5 is a perspective view of another embodiment of a metal-oxide-metal capacitor according to the present invention;

FIG. 6(A) is a schematic drawing showing a bottom view of a cross section of an external conductive plate and a parallel conducting layer on a top end of an embodiment according to the present invention;

FIG. 6(B) is a schematic drawing showing a top view of a cross section of an external conductive plate and a parallel conducting layer on a top end of an embodiment according to the present invention;

FIG. 6(C) is a schematic drawing showing a cross section between two parallel conducting layers of an embodiment according to the present invention;

FIG. 6(D) is a schematic drawing showing a top view of a cross section of an external conductive plate and a parallel conducting layer on a bottom end of an embodiment according to the present invention;

FIG. 7 is a cross sectional view taken along a line A-A of the embodiment in FIG. 6(B);

FIG. 8 is a circuit layout diagram of a 10-bit successive-approximation ADC available now;

FIG. 9 is a perspective view of a metal-oxide-metal capacitor available now; and

FIG. 10 is a schematic drawing showing layout of a capacitor array when metal-oxide-metal capacitors available now are applied to digital-to-analog converters.

### DETAILED DESCRIPTION OF THE PREFERRED EMBODIMENT

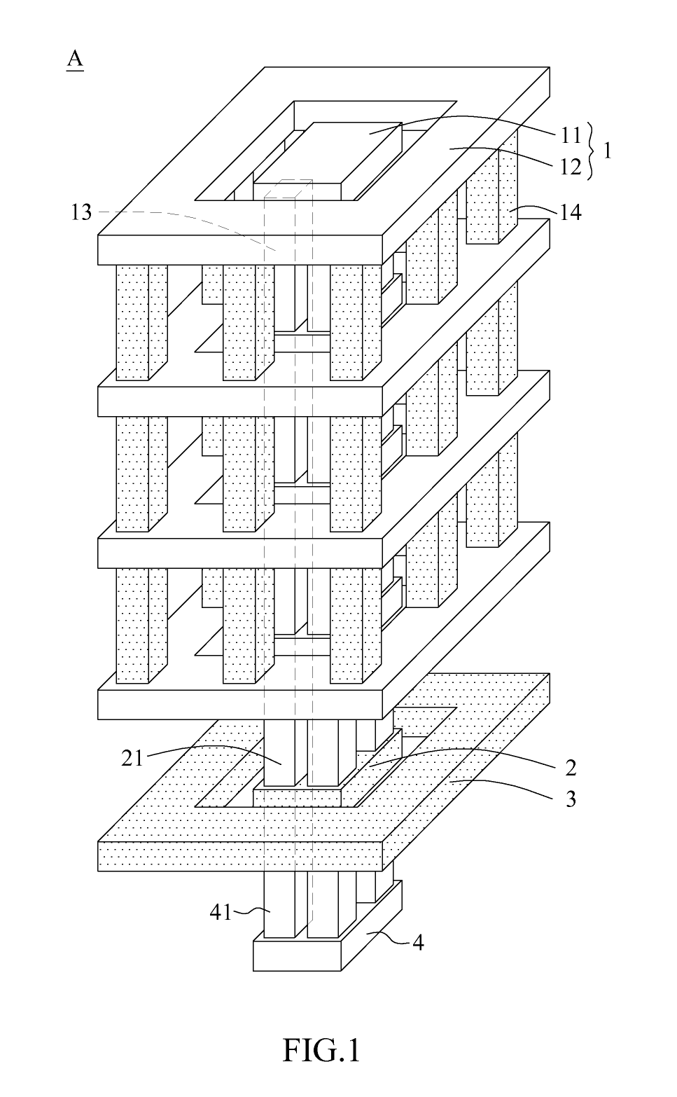

Referring to FIG. 1, a perspective view of an embodiment of a metal-oxide-metal (MOM) capacitor able to reduce area of capacitor arrays according to the present invention is revealed. The MOM capacitor mainly includes at least three parallel conducting layers 1. Each of the parallel conducting layers 1 consists of a first conductive plate 11, a second conductive plate 12, at least one first via 13, and at least one second via 14. The second conductive plate 12 is corresponding to and arranged around the first conductive plate 11 and there is a preset distance between the first conductive plate 11 and the second conductive plate 12. The first conductive plates 11 are electrically connected by the first via 13 while the second conductive plates 12 are electrically connected by the second via 14. In this embodiment, there are four parallel conducting layers 1. The first conductive plates 11 are electrically connected to one another by four (2×2) first vias 13. As to the second conductive plates 12, they are electrically connected by eight second vias 14 (each side arranged with 3 vias). For people skilled in the art, the above first via 13 and the second via 14 can be arranged in other forms.

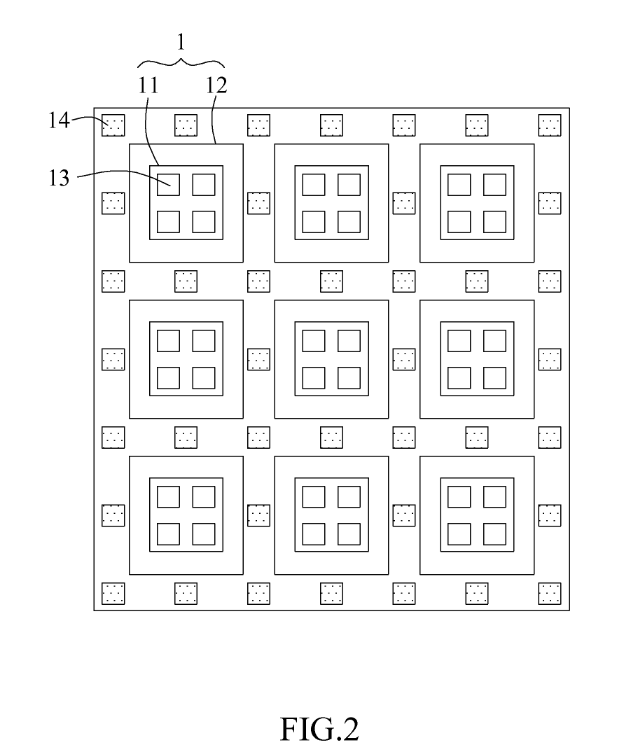

Referring to FIG. 2, an embodiment of the present invention is applied to a digital-to-analog converter (DAC). A schematic drawing showing capacitor array layout is revealed. When a metal-oxide-metal (MOM) capacitor (A) of the present invention is applied to a capacitor array, the second conductive plates 12 of the two adjacent MOM capacitors are connected together and shared with each other. In the figure, it is found that there are only 40 second vias when 9 MOM capacitors (A) are arranged into a 3×3 capacitor array. If the second conductive plates 12 are not connected together and shared with each other, 72 second vias 14 are needed. Generally, the MOM capacitor (A) includes conductive material such as metal and dielectric material such as oxide used to form an insulation layer. The main design concept of the present invention is to shape the MOM capacitor (A) into a column. The first conductive plates 11 are connected in series to form a column in a core and the column is used as a bottom plate of the capacitor while the second conductive plates 12 are connected in series to form a column around the first conductive plates 11 and the column of the second conductive plates 12 are used as a top plate of the capacitor. Thus the first conductive plate 11 and the second conductive plate 12 are of opposite electricities. Moreover, the conductive material and dielectric material of the first and the second conductive plates 11, 12 are not limited. General or novel conductive material and dielectric material can be applied to the MOM capacitor (A) of the present invention.

Furthermore, the first conductive plate 11 on one end is electrically connected to a first metal plate 2 by at least one third via 21. And at least one metal shielding layer 3 is disposed around the first metal plate 2. Moreover, the first metal plate 2 is electrically connected to a second metal plate 4 by at least one fourth via 41. The metal shielding layer 3 is used to electrically isolate the second metal plate 4 from the second conductive plate 12 so as to prevent the second metal plate 4 from being affected by the capacitance of the second conductive plate 12 or other conductive structures thereabove. In addition, in an embodiment of the present invention, the shape of the metal shielding layer 3 is corresponding to the shape of the second conductive plate 12.

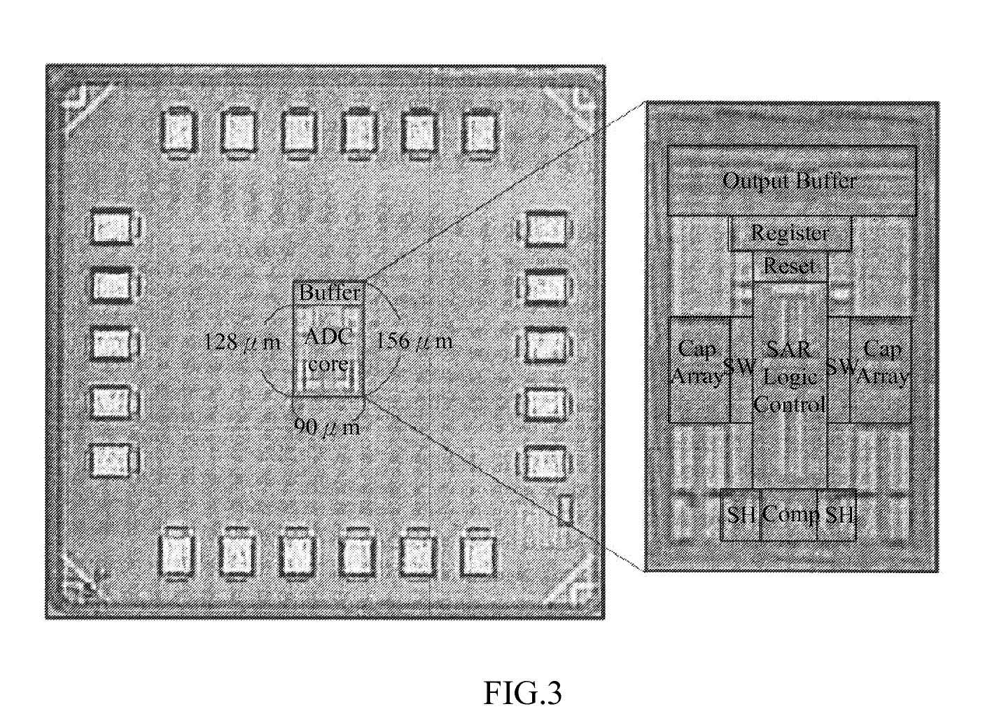

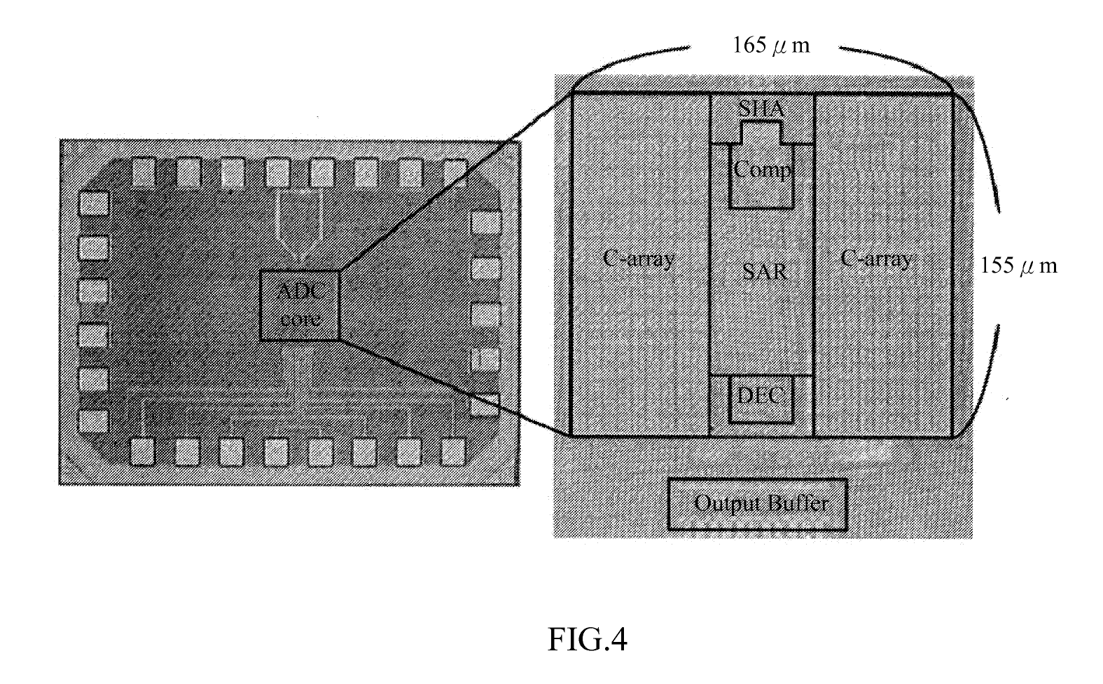

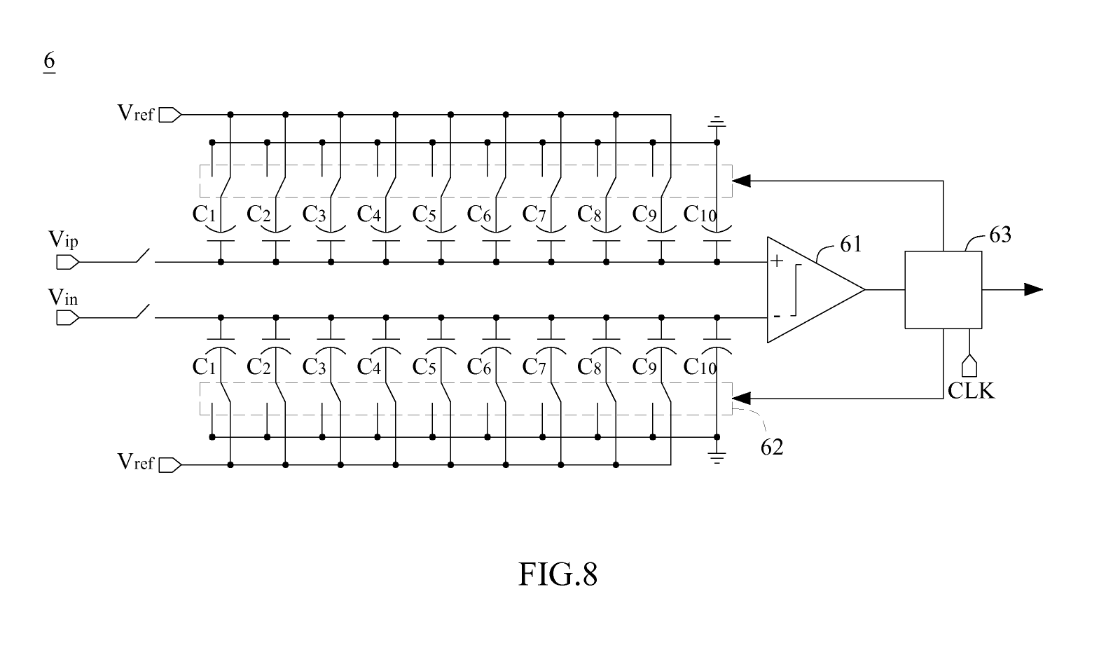

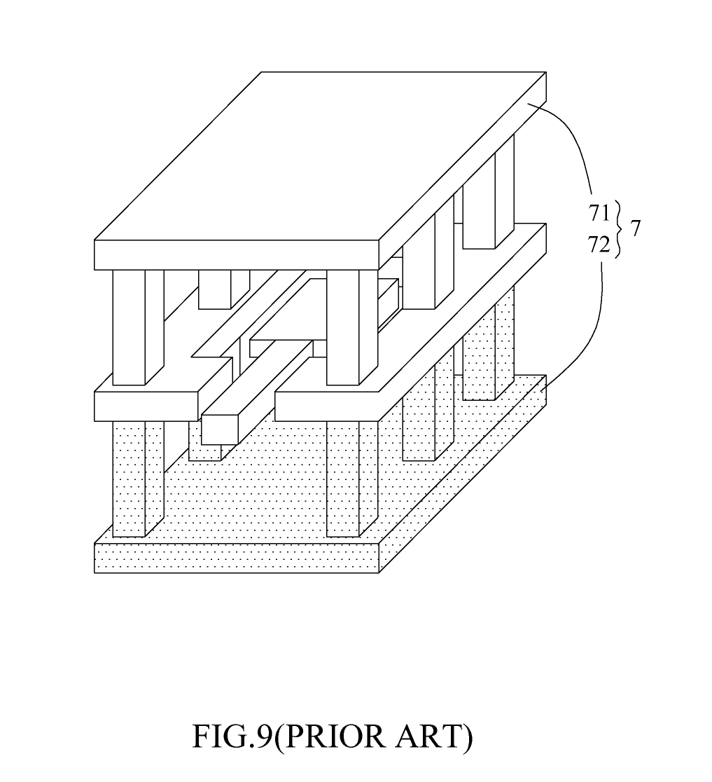

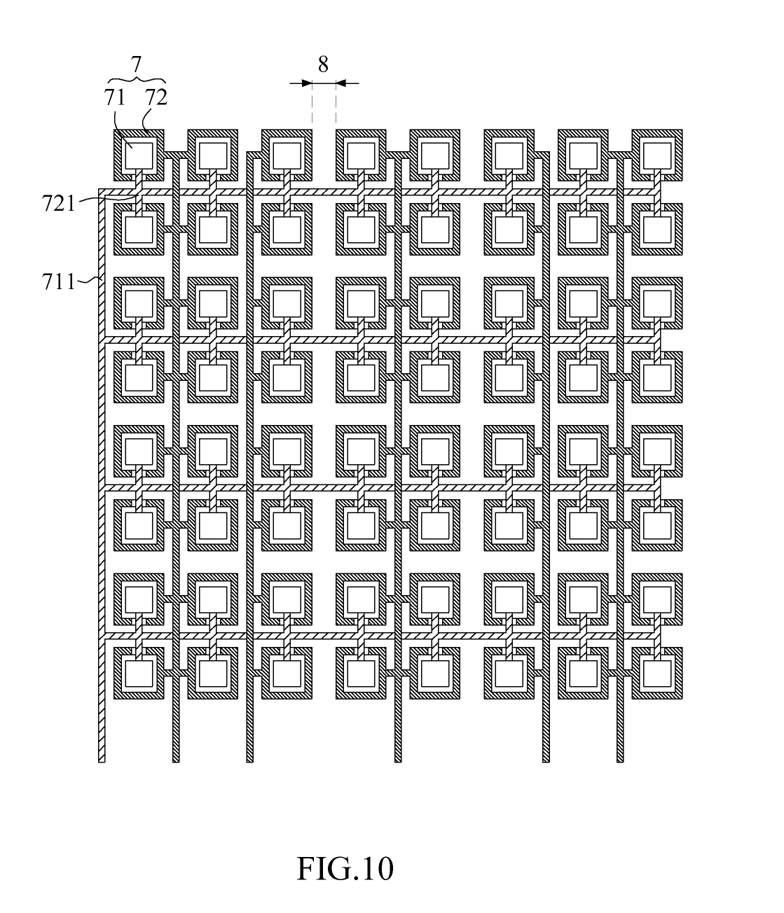

When the above SAR ADC with reduced area of capacitor array is in use, referring to FIG. 8, the top plates of C₁˜C₁₀ are connected to one another so that the capacitor array of C₁˜C₁₀ has the feature of the present invention that the second conductive plates 12 are connected together and shared with each other. Thus there is no need to leave some channel for placement and routing between two adjacent MOM capacitors (A). The placement and routing of the bottom plate are achieved by the metal layer on the lowest layer (such as the second metal plate 4 in FIG. 1). Thereby the area of the capacitor array is dramatically reduced and circuit density is increased. The layout efficiency of the chip design is further optimized. Referring to FIG. 3 and FIG. 4, they are photos of the present invention and of MOM capacitor array on a SAR ADC chip available now. It is shown clearly in FIG. 4 that the capacitor array (C-array) formed by MOM capacitors (A) available now has covered over nearly two-thirds of the total area of the ADC core. It covers the most of the area of the ADC. On the other hand, referring to FIG. 3, the capacitor array (C-array) formed by MOM capacitors (A) of the present invention covers only 35% of the total area of the ADC core, the ratio is significantly reduced. Thus the present invention dramatically reduces the area of the capacitor array formed by the MOM capacitors (A) and further minimizes the chip area. Moreover, the MOM capacitor (A) of the present invention design in a column form can also be minimized into quite a small scale. Thus the distance between the first conductive plate 11 and the second conductive plate 12 is shortened and a larger capacitance is produced. Furthermore, the first conductive plate 11 is enclosed in the second conductive plate 12. Thus parasitic capacitance of the first conductive plate 11 to the ground is smaller.

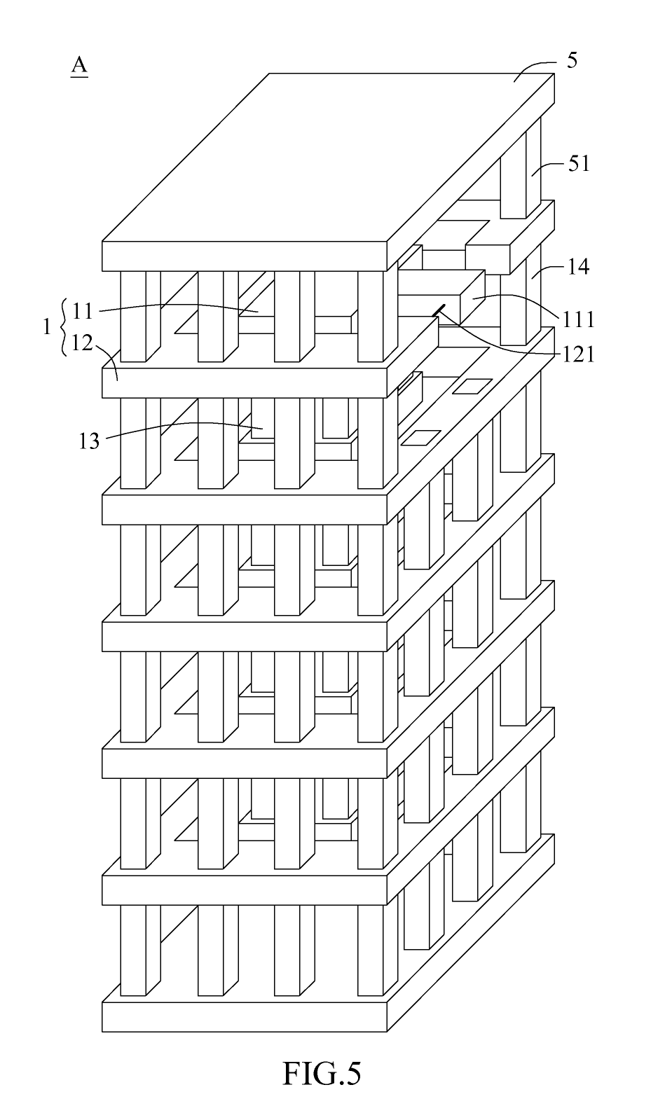

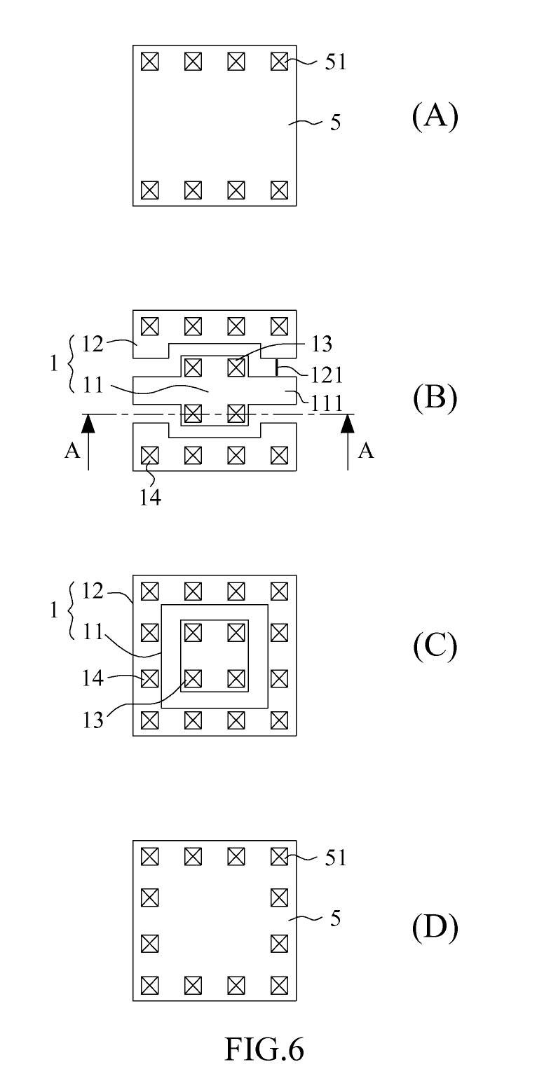

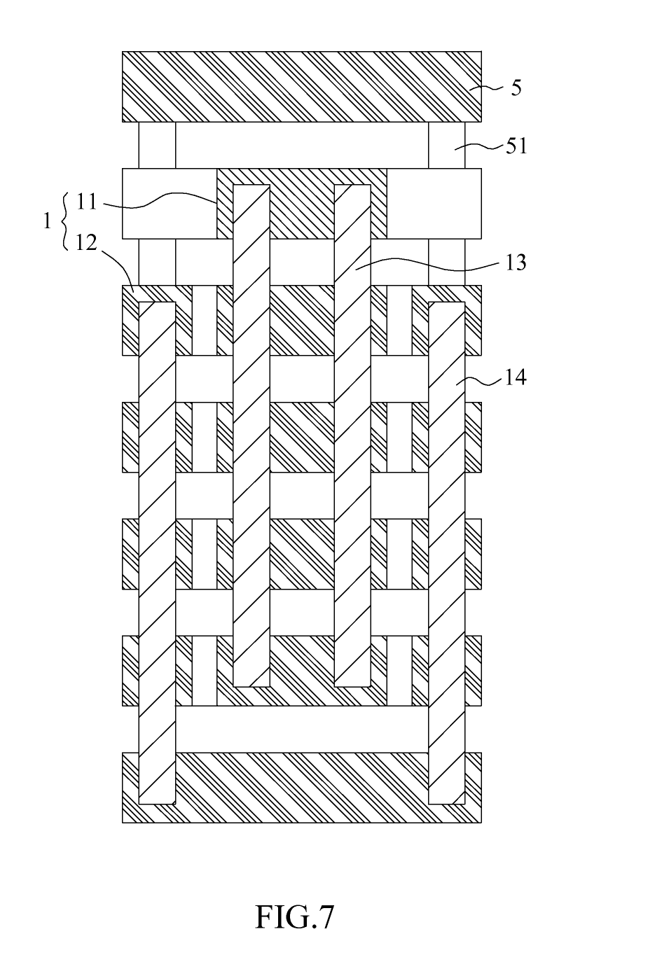

Referring to FIG. 5, another embodiment of a MOM capacitor is revealed. The difference between this embodiment and the above is that this embodiment includes at least one parallel conducting layer 1 having at least one first conductive plate 11 and at least one second conductive plate 12. At least one through slot 121 is disposed on the second conductive plate 12 of at least one parallel conducting layer 1 while an electrical guiding part 111 corresponding to the through slot 121 is projectingly disposed on the first conductive plate 11. In this embodiment, each of two sides of the second conductive plate 12 on a top end is disposed with a through slot 121 while the first conductive plate 11 is arranged with two electrical guiding parts 111 corresponding to the above two through slots 121 respectively. Moreover, the parallel conducting layer 1 on each of two ends is electrically connected to an external conductive plate 5 by at least one fifth via 51. Referring to FIG. 6 and FIG. 7, the first conductive plates 11 are electrically connected by first vias 13. The capacitance of each parallel conducting layer 1 is added due to parallel connection so as to form an electrode of a MOM capacitor (A) of the present invention. The second conductive plates 12 are electrically connected by second vias 14 so as to form the other electrode of the capacitor. As shown in FIG. 6(B), the first conductive plate 11 is electrically connected to another MOM capacitor (A) by the extended electrical guiding part 111. Thereby a plurality of MOM capacitors (A) can be connected horizontally so as to achieve the capacitance required.

In summary, the present invention has the following advantages compared to the technique available now:
1. The MOM capacitor of the present invention is designed into a column. Thus the first conductive plates connected in series to form a column in a core is used as a bottom plate of the capacitor while the second conductive plates connected in series to form a column around the first conductive plates is used as a top plate of the capacitor. While being applied to capacitor arrays, the layout area is dramatically reduced and the circuit density is increased. Thus the chip area is reduced significantly.
2. When the MOM capacitor of the present invention is applied to the successive-approximation ADC, there is no need to have channels for placement and layout between two adjacent MOM capacitors due to connection and sharing of the second conductive plates. The area used on the chip is significantly reduced and the layout efficiency of the chip design is optimized dramatically.
3. In the MOM capacitor of the present invention, the first conductive plate is enclosed in the second conductive plate. Thus parasitic capacitance of the first conductive plate 11 to the ground is smaller.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A metal-oxide-metal (MOM) capacitor able to reduce area of capacitor arrays comprising: at least three parallel conducting layers, each parallel conducting layer including a first conductive plate, a second conductive plate disposed around the first conductive plate, and a preset distance between the first conductive plate and the second conductive plate; the first conductive plates are electrically connected by at least one first via while the second conductive plates are electrically connected by at least one second via; wherein the second conductive plates of two adjacent MOM capacitors are connected together and shared with each other when the MOM capacitor is applied to capacitor arrays.

2. The device set forth in claim 1, wherein the first conductive plate on one end is electrically connected to a first metal plate.

3. The device set forth in claim 2, wherein the first conductive plate is electrically connected to the first metal plate by at least one third via.

4. The device set forth in claim 2, wherein a metal shielding layer is disposed around the first metal plate and the first metal plate is further electrically connected to a second metal plate; the second metal plate and the second conductive plate are electrically isolated.

5. The device set forth in claim 4, wherein the first metal plate is further electrically connected to the second metal plate by at least one fourth via.

6. The device set forth in claim 4, wherein a shape of the metal shielding layer is corresponding to a shape of the second conductive plate.

7. The device set forth in claim 1, wherein the first conductive plate and the second conductive plate are of opposite electricities.

8. A metal-oxide-metal (MOM) capacitor able to reduce area of capacitor arrays comprising: at least three parallel conducting layers, each parallel conducting layer including a first conductive plate, a second conductive plate disposed around the first conductive plate, and a preset distance between the first conductive plate and the second conductive plate; the first conductive plates are electrically connected by at least one first via while the second conductive plates are electrically connected by at least one second via; wherein at least one through slot is disposed on the second conductive plate of at least one parallel conducting layer and an electrical guiding part corresponding to the through slot is projectingly arranged at the first conductive plate.

9. The device set forth in claim 8, wherein the parallel conducting layer on each of two ends is electrically connected to an external conductive plate respectively.

10. The device set forth in claim 9, wherein the parallel conducting layer is electrically connected to the external conductive plate by at least one fifth via.

11. The device set forth in claim 8, wherein the first conductive plate and the second conductive plate are of opposite electricities.
